(19) United States
(12) Patent Application Publication
(10) Pub. No.: US 2015/0196185 A1
(43) Pub. Date: Jul. 16, 2015

(54) Soap Infused Towel

(71) Applicant: John M. Fiske, Port St. Lucie, FL (US)

(72) Inventor: John M. Fiske, Port St. Lucie, FL (US)

(21) Appl. No.: 14/595,752

(22) Filed: Jan. 13, 2015

Related U.S. Application Data
(60) Provisional application No. 61/926,698, filed on Jan. 13, 2014.

(51) Int. Cl. A47L 13/17; B05D 1/28; A47K 7/03

(52) U.S. Cl. CPC A47L 13/17; A47K 7/03; B05D 1/28

(57) ABSTRACT

An infused article includes a substrate infused with an infusion component. The substrate may be an absorbent material and the infusion component may include a soap, dyed soap, or an ink and soap. The infusion component may also include a cleaner, which may include the soap, a wax, or a therapeutic agent. The infused article may be hydrated from a dehydrated state to release the infusion component.

### TECHNICAL FIELD

The present description relates generally to infusion of a substrate with an infusion component and, more specifically, to infused articles and methods to make infused articles using modified screen printing techniques.

### BACKGROUND

Treating surfaces such as skin, countertops, and vehicle finishes generally requires using multiple cleaning implements. For example, when cleaning a surface with a soap or cleaner, application of the cleaner to the surface to be cleaned typically requires transferring the cleaner from a storage container by, for example, pouring or spraying the cleaner onto the surface. This transfer step, however, may lack efficiency and result in wasteful overspray. Following application of the cleaner to the surface, another implement, such as a towel, is commonly used to enhance the cleaning action by loosening dirt or debris from the surface or to further expose the dirt or debris to the cleaner. The same or another implement may also be used to remove the dirt or debris from the surface. What are needed are convenient alternatives to reduce the number of implements and steps needed to treat surfaces.

### SUMMARY

In one aspect, an infused article comprises a substrate and an infusion component infused with the substrate. The substrate may comprise an absorbent material and the infusion component may comprise a soap or a dyed soap. In one embodiment, the infused article comprises an infused portion dyed with the dyed soap. The infused article may further comprises a design dyed on the infused portion with an ink or the dyed soap. The infused article may also be configured to be dried. In one embodiment, the infusion component comprises a soap and at least one of a household cleaner, a therapeutic agent, and a wax.

In one aspect, a method for making an infused article comprises applying a liquid comprising a soap to a screen that is registered adjacent to a substrate. The screen comprises an open screened region configured to allow the liquid to permeate through the screen. The method further comprises infusing the substrate with the soap. The infusing comprises contacting the substrate with the liquid permeating the screen. The method further comprises drying the substrate contacted with the liquid. In one embodiment, the contacting further comprises saturating the substrate with the liquid permeating the screen. The method may further comprise urging the liquid to permeate the screen with a tool. In one embodiment, the method further comprises dying the substrate with an ink or dye. The liquid may further comprise the dye and the dying may comprise the contacting of the substrate with the liquid permeating the screen. The open screened region may define a design. In one embodiment, the method further comprises printing a design on the substrate before or after contacting the substrate with the soap. The printing is performed when the substrate is dry. In one embodiment, the printing comprises applying a second liquid comprising an ink o dye to a second screen registered adjacent to the substrate. The second screen comprises a second open region defining a design and is configured to allow the second liquid to permeate through the second screen. The printing further comprises contacting the substrate with the second liquid permeating the second screen and drying the substrate. In one embodiment, the second liquid further comprises a second infusion component comprising at least one of a second soap, a household cleaner, a therapeutic agent, and a wax.

In another aspect, a method for infusing an absorbent article with an infusion component comprises applying a liquid comprising an infusion component to a screen positioned over an absorbent article. The screen comprises an open screened region. The method further comprises contacting the absorbent article with a portion of the liquid permeating the open screened region to infuse the absorbent article with the infusion component. The method further comprises drying the absorbent article infused with the infusion component to produce an infused article, wherein the infused article is configured to be packaged dry. In one embodiment, the infusion component comprises a soap. In a further embodiment, the infusion component further comprises one of a therapeutic agent, a household cleaner, a wax, a fragrance, a skin softener, and a conditioner.

### FIGURES

The novel features of the described embodiments are set forth with particularity in the appended claims. The described embodiments, however, both as to organization and manner of operation, may be best understood by reference to the following description, taken in conjunction with the accompanying drawings in which:

FIG. 1 illustrates a press setup for contacting a substrate with a liquid comprising an infusion component according to various embodiments described herein; and

FIG. 2 illustrates contacting the substrate with the liquid comprising the infusion component using the press setup shown in FIG. 1 according to various embodiments described herein.

### DESCRIPTION

According to various embodiments, an infused article comprises a substrate infused with an infusion component. Typically the substrate may be infused with the infusion component by contacting or saturating the substrate with a liquid comprising the infusion component. The liquid may comprise a composition having a liquid phase such as a mixture, solution, suspension, or colloid. In one embodiment, the liquid includes the infusion component in a liquid phase. The contact is configured to infuse, e.g., associate or impart, the substrate with the infusion component associated with the liquid. For example, in certain embodiments, the substrate comprises an absorbent material configured to absorb the infusion component when contacted with the liquid. As such, in various embodiments, a method for making an infused article comprises contacting the substrate with the liquid such that the substrate becomes infused with the infusion component. In one embodiment, the infusion component is infused with the substrate such that the infused article may be subsequently dried and, in some instances, stably packaged for an extended shelf-life. In use, the infused article may be configured to release the infusion component from the substrate.

In various embodiments, the liquid or infusion component comprises properties configured to assist in infusion or association of the infusion component with the substrate. For example, the structure of the substrate may be configured to favor absorption or association of the infusion component. In certain embodiment, the infusion component and the substrate are configured to molecularly interact via polar or dipole interactions, hydrogen bonding, electrostatic interactions, van der waals forces, hydrophilic or hydrophobic interactions, for example. In one embodiment, the infusion component and the substrate are configured to form an ionic or covalent bond. As such, in various embodiments, the interaction between the infusion component and the substrate may favor association during contact and favor disassociation during release, which may be modulated to control release characteristics of the infusion component with respect to the infused article.

As introduced above, the infused article may be configured to release the infusion component from the substrate. The substrate infused with the infusion component, for example a water based or soluble infusion component, may be subsequently dehydrated to produce the infused article. In such a dehydrated state, the infusion component may be associated with the substrate until the time of desired use at which time the infused article may be rehydrated to release the infusion component from the infused article. Release of the infusion component from the substrate may include assistance or application of a extractor or releasing agent. For example, in various embodiments, a releasing agent comprises a gas, abrasive, solvent, such as water, alcohol, oils, or sweat configured to assist in release of the infusion component. In certain embodiments, an extractor comprises application of thermal energy or abrasion. The infusion component may be released from the substrate in any suitable form, e.g., a liquid, semi-solid, lotion, ointment, or gel, which may, in certain embodiments, also include a portion of the releasing agent. In some embodiments, the infusion component is configured to be released, at least partially, in a liquid phase. In certain embodiments, the infusion component may also include properties configured to modulate release of one or more properties or portions of an infused portion of the infused component.

According to certain embodiments, properties of the liquid or infusion components may comprise basic, acidic, enzymatic, catalytic, inhibitory, electro affinity or repulsion, redox, hydrophilic, hydrophobic, repentant, attractive, corrosive, anticorrosive, cosmetic, scent, hydrating, sealant, adhesive, antiseptic, anti-fungal, anti-microbial, or other properties. In certain embodiments, the infused article may be infused with such properties via the association and releasability of the infusion component.

The substrate and infused component may be chosen to provide a desired character or use with respect to the infused article. For example, in one embodiment, an infused article may be used to lather or wash hands with soap. Accordingly, the infused article may comprise a substrate comprising a towel infused with an infusion component comprising a hand soap. Subsequently contacting the infused article with water, for example, may cause the hand soap to be released in whole or in-part, depending on the desired configuration, from the towel. In other embodiments, infusion components may comprise bath, body, vehicle, dish, laundry or other soaps typically associated with specific purposes. For example, in one embodiment, the liquid comprises an infusion component comprising a dog shampoo. The dog shampoo, in one embodiment, further comprises a therapeutic agent such as an emollient, a topical medication, or a flea, tick, or other pest repellant. As such, an embodiment of the infused article configured for pet applications may comprise a substrate comprising a towel so infused and that upon hydration may release the infusion component, e.g., an oatmeal flea and tick shampoo.

Infusion components may also include cleaners such as soaps, commercial, e.g., industrial strength, or household cleaning products such as all-purpose cleaners, oxy cleaners, bleach cleaners, and combinations thereof may also be used. Likewise, in one embodiment, an infused article configured to wax a surface may comprise a substrate contacted with a liquid comprising an infusion component such as a wax. The infused article may be dried and packaged for storage prior to application of the cleaner or wax to the surface to be waxed which may be assisted by a releasing agent or extractor, as described above. As introduced above, infused articles may also include substrates infused with infusion components comprising therapeutic agents such medicines, chemical compounds, ointments, disinfectants, skin treatments such as conditioners and softeners, sanitizers, as well as other infusion components including, for example, alcohols, cosmetics, paints, fragrances, conditioners, degreasers, tar removers, road grime or bug removers, or other desired infusion component.

In some embodiments, the substrate comprises an absorbent article, such as a towel. The absorbent article may, for example, comprise fabric, paper, synthetic or organic fibers or polymers, or other materials configured to absorb an infusion component. In one embodiment, contacting the substrate comprises saturating the absorbent article with the liquid comprising the infusion component. In various embodiments, the liquid comprising the infusion component further comprises an ink or dye. Contacting the substrate with the ink or dye may infuse the ink or dye and the infusion component with the substrate. In one embodiment, the ink or dye is configured to be retained or substantially retained by the infused article when the infusion component is released from the infused article. In another embodiment, release of the infusion component at least partially coincides with release of ink or dye from the infused article. Thus, in certain configurations, the amount of ink or dye may be used as a gage for predicting the amount of infusion component remaining in the infused article. For example, an ink or dye infused soap infusion component may be infused, e.g., printed, saturated, absorbed, coupled, or otherwise adhered or associated, with the substrate. When the soap infusion component is released from the infused article, the ink or dye is similarly released. It will be appreciated that, in some embodiments, the ink or dye may be configured to disfavor association with one or more surfaces, such as surfaces to be cleaned. Similarly, in certain embodiments, the substrate may comprise regions that disfavor infusion by the infusion component or dye.

In certain embodiments, contacting the substrate with the liquid for infusion of the substrate with the infusion component comprises a method for saturating the substrate with the liquid such that the infusion component infuses with the substrate to produce the infusion article. In some embodiments, a modified screen printing process may be employed to saturate the substrate with the liquid and thereby infuse the substrate with the infusion component. For example, in one embodiment, the substrate comprises an absorbent article. A screen having an open screened area may be positioned or registered above the substrate. The liquid comprising the infusion component may be added to the screen, and a tool such as a squeegee may be used in conjunction with the screen to saturate the substrate with the liquid. The amount of liquid absorbed or the extent the substrate is saturated may be partially modulated by the number of times the tool is passed over the screen to urge the liquid to pass through the opened screened area into contact with the substrate. It will be appreciated that other variables, such as viscosity of the liquid, type of tool used, angle of the tool, speed of the pass of the tool, area or width of the tool, mesh size within the opened screened area, absorbent properties of the substrate, and molecular interaction between the liquid and the substrate and regions thereof may also affect that amount of liquid absorbed or the extent of saturation.

In various embodiments, the liquid may be contacted with a substrate to produce an infused article comprising a design or printed media. In one embodiment, the printing media comprises a water based ink. In such embodiments, it is typically preferable to print the substrate with the water based ink prior to contacting the substrate with the liquid for infusion comprising the infusion component to produce the infusion article. For example, a printed substrate comprising a design may be infused with an infusion component as herein described.

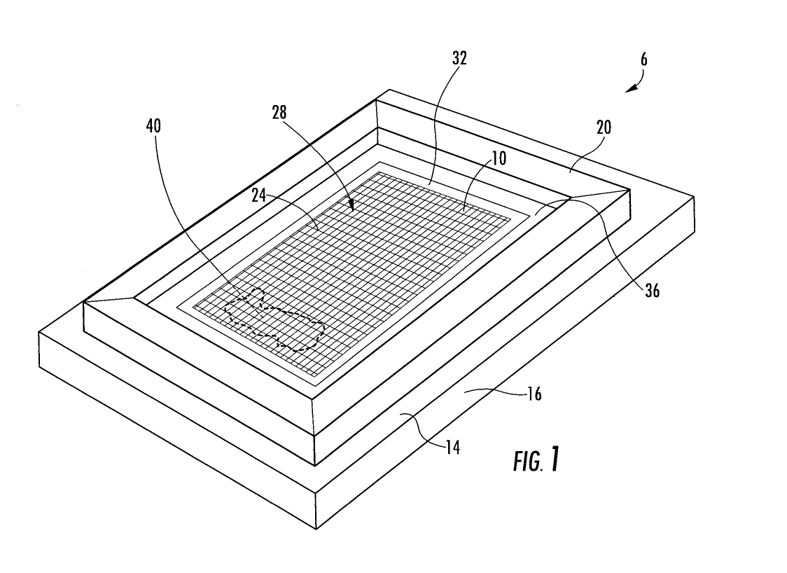

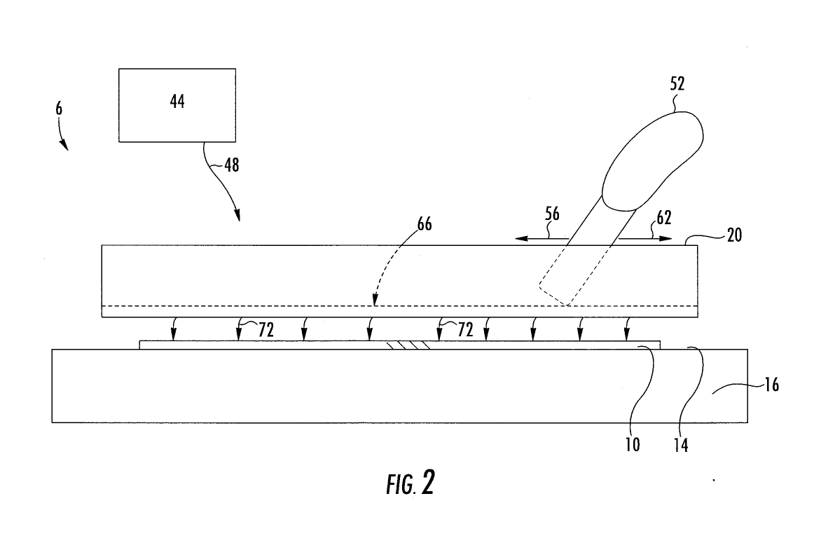

An exemplary method of infusing a substrate with an infusion component using a modified screen printing press apparatus 6 is illustrated in FIGS. 1-2. Referring to FIG. 1, a substrate 10 is positioned on a surface 14 of a palate 16. A frame 20 comprising a screen 24 having open screened area 28 is registered over the substrate 10. The screen 24 includes masked portions such as emulsion portions 32 defining the opened screened area 28, which may define a design, and a tape portion 32 that couples the screen 28 and frame 20. In various embodiments, the open screened area 28 comprises an area about the same size of the area of the substrate 10, however, in other embodiments, the opened screened area 28 may be smaller than the area of the substrate 10. For example, in one embodiment, the open screened area 28 of the screen 24 comprises an area ¼ to ⅛ inches less than the substrate 10. It will be appreciated that the open screened area 28 may also be greater than the area of the substrate 10 without departing from the present disclosure. In the illustrated embodiment, the substrate 10 comprises a 11×17 inch towel and the screen 24 is about 3 to 4 inches larger than the substrate 10 and art work 40, which may be pre-printed on the substrate or subsequently printed with a second screen, and may include infusion with a liquid comprising an ink or dye and soap infusion component. Notably, when the liquid comprises an ink or dye and soap infusion component, the emulsion portions 32 may define a design or art 40 and contacting the substrate 10 with the liquid for infusion with the infusion component may comprise dying the substrate. Of course, multiple infusion patterns and colors of inks or dyes or infusion components may be subsequently infused with the substrate as desired.

liquid 44 comprising an infusion component is added 48 to the screen 24 as shown in FIG. 2. A tool 52 comprising a squeegee is then passed over the screen 24 in directions 56 and 62. The tool 52 urges the liquid 44, depicted as dashed line 66, through the mesh of the screen 24 within the open screened area 28, as generally shown as lines 72 permeating the open screened area 28 at an opposing side of the screen 24. As described above, the amount of liquid 44 absorbed or the extent the substrate 10 is saturated may be modulated by the number of times the tool 52 is passed over the screen 24 to urge the liquid 44 to pass through the mesh within the open screened area 28 into contact with the substrate 10. It will be appreciated that other variables, such as viscosity of the liquid 44, type of tool 52 used, angle of the tool 52, speed of the pass of the tool 52, area or width of the tool 52, mesh size of the screen 24 within the opened screened area 28, absorbent properties of the substrate 10, and molecular interaction between the liquid 44 and the substrate 10 may also affect that amount of liquid 44 absorbed or the extent of saturation. Thus, taking into account the above variables, desired absorption and saturation may be controlled. In various embodiments, the open screened area 28 comprises a mesh preferably having about 70-86 per square inch thread count, however, as described above, optimal mesh size may be less than or greater to account for other variables such as liquids having greater or less viscosity, for example. Following contact, e.g., leading to saturation, with the liquid, the infused article comprising the substrate 10 is thoroughly dried. According to one embodiment, efficient drying is accomplished in a forced air dryer. In various embodiments, the dried infused article may be packaged or further processed, e.g., printed with art,

As introduced above, in one embodiment, the liquid 44 comprising the infusion component that is contacted with the substrate 10 further comprises an ink or dye. Therefore, contact and saturation with the liquid 44 further comprises infusion with the ink or dye to thereby provided color to a portion of the substrate 10 saturated with the liquid 44.

Whether or not the liquid 44 contacted with the substrate 10 comprises an ink or dye, art 10, such as logos, insignia, etc., may be printed on the substrate 10. In general, printing of art 10 with respect to saturation when the liquid may depend on the printing media selected. For example, if art 40 is printed using a water based ink, the art 40 is preferably printed and dried before contact or saturation with the liquid 44. Alternatively, if art 40 is to be printed with a dyed soap or second liquid comprising a second infusion component, which may be the same or different than the first infusion component, the art 40 is preferably printed on the dried substrate 10 comprising the infused article after contact or saturation of the substrate 10 with the first liquid 44 comprising the first infusion component.

According to various embodiments, art 44 may be printed on the substrate 10 or infused article by any method known in the art. Briefly, designs comprising artwork are preferably presented in camera ready form. For multi-color designs, colors are preferably separated. Each separation is preferably printed on film or vellum in black, and the separations are separately registered on top of each other to create a full composited design. For one color designs, a composite of artwork only may be needed. Depending on art separations, one or more screen thread counts may be used. For example, in one embodiment, a thread count of 110 per square inch is preferable. In other embodiments, for example embodiments requiring art with finer detail, thread counts of 150-160 per square inch may be suitable. That is, as described above with respect to the liquid 44 comprising the infusion component, higher thread counts require liquid or ink having thinner viscosities. For best results, preparation of each screen 24 for printing comprises cleaning, degreasing, and drying the screen 24 prior coating the screen 24 with emulsion 32. The emulsion 32 coated screen 24 is preferably dried in the dark, e.g., in a dark drying cabinet print side down until dried. After the screen 24 is dried, the artwork is registered on the one or more screens 24 and exposed to ultra violet light for the required length of time, e.g., depending on the type of exposing unit used. Following exposure, the unexposed area of the screen 24 that was blocked from the ultra violet light by the artwork is washed using a gentle stream of water. The screen is then left to dry and subsequently taped off prior to set up in the screen press 6.

The present disclosure may be embodied in other forms without departing from the spirit or essential attributes thereof and, accordingly, reference should be had to the following claims rather than the foregoing specification as indicating the scope of the disclosure. Further, the illustrations of arrangements described herein are intended to provide a general understanding of the various embodiments, and they are not intended to serve as a complete description. Many other arrangements will be apparent to those of skill in the art upon reviewing the above description. Other arrangements may be utilized and derived therefrom, such that logical substitutions and changes may be made without departing from the scope of this disclosure.

This disclosure is intended to cover any and all adaptations or variations of various embodiments and arrangements. Combinations of the above arrangements, and other arrangements not specifically described herein, will be apparent to those of skill in the art upon reviewing the above description.

What is claimed is:

1. An infused article comprising:
a substrate; and
an infusion component infused with the substrate.

2. The infused article of claim 1, wherein the substrate comprises an absorbent material.

3. The infused article of claim 2, wherein the infusion component comprises one of a soap, a household cleaner, a commercial cleaner, a therapeutic agent, and a wax.

4. The infused article of claim 3, wherein the infusion component further comprises an ink or dyed soap.

5. The infused article of claim 4, wherein the infused article comprises an infused portion, wherein the infused portion comprises a dyed portion dyed with the ink or dyed soap.

6. The infused article of claim 5, further comprising a design dyed on the dyed portion with the ink or dyed soap.

7. The infused article of claim 6, wherein the infusion component is water based such that the infused article retains the infusion component when dehydrated and is configured to release the soap when rehydrated.

8. The infused article of claim 1, wherein the infusion component comprises a soap and at least one of a household cleaner, a commercial cleaner, a therapeutic agent, and a wax.

9. A method for making an infused article, the method comprising:
applying a liquid comprising a soap to a screen registered adjacent to a substrate, wherein the screen comprises an open screened region configured to allow the liquid to permeate through the screen;
infusing the substrate with the soap, wherein the infusing comprises contacting the substrate with the liquid permeating the screen; and
drying the substrate contacted with the liquid.

10. The method of claim 9, wherein the contacting further comprises saturating the substrate with the liquid permeating the screen.

11. The method of claim 9, further comprising urging the liquid to permeate the screen with a tool.

12. The method of claim 9, further comprising dying the substrate with an ink or dye.

13. The method of claim 12, wherein the liquid further comprises the ink or dye, and wherein the dying comprises the contacting of the substrate with the liquid permeating the screen.

14. The method of claim 13, wherein the open screened region defines a design.

15. The method of claim 9, further comprising printing a design on the substrate before or after contacting the substrate with the soap, wherein the printing is performed when the substrate is dry.

16. The method of claim 15, wherein the printing comprises,
applying a second liquid comprising an ink or dye to a second screen registered adjacent to the substrate, wherein the second screen comprises a second open region defining a design and configured to allow the second liquid to permeate the second screen,
contacting the substrate with the second liquid permeating the second screen; and
drying the substrate.

17. The method of claim 15, wherein the second liquid further comprises a second infusion component comprising at least one of a second soap, a household cleaner, a commercial cleaner, a therapeutic agent, and a wax.

18. A method of infusing an absorbent article with an infusion component, the method comprising:
applying a liquid comprising an infusion component to a screen positioned over an absorbent article, wherein the screen comprises an open screened region;
contacting the absorbent article with a volume of the liquid permeating the open screened region to infuse the absorbent article with the infusion component; and
drying the absorbent article infused with the infusion component to produce an infused article, wherein the infused article is configured to be packaged dry.

19. The method of claim 18, wherein the infusion component comprises a soap.

20. The method of claim 19, wherein the infusion component further comprises one of a therapeutic agent, a household cleaner, commercial cleaner, a wax, a fragrance, a skin softener, and a conditioner.
